(19) United States
(12) Patent Application Publication
(10) Pub. No.: US 2026/0024156 A1
(43) Pub. Date: Jan. 22, 2026

(54) GENERATING PROFILES FOR AI TEACHERS IN AN ONLINE LEARNING PLATFORM USING INTEGRATED PROGRAMMATIC AND SPECIALIZED GUIDED AND CONSTRAINED ARTIFICIAL INTELLIGENCE

(71) Applicant: 2hr Learning, Inc., Austin, TX (US)

(72) Inventors: Philip Hewinson, Woking (GB); Samy Aboel-Nil, Austin, TX (US); Niraj Patel, Dubai (AE); Janet Demir, Ortaca (TR); Akshay Mate, Nanaimo (CA); Hossam Arafat, Rome (IT); Pranav Nambiar, Bengaluru (IN); Eduardo Baccin, Joinville (BR)

(73) Assignee: 2hr Learning, Inc., Austin, TX (US)

(21) Appl. No.: 19/269,838

(22) Filed: Jul. 15, 2025

Related U.S. Application Data
(60) Provisional application No. 63/671,762, filed on Jul. 16, 2024.

(51) Int. Cl. G06Q 50/20; G06Q 50/00; G09B 5/14

(52) U.S. Cl. CPC G06Q 50/205; G06Q 50/01; G09B 5/14

(57) ABSTRACT

The system and method combine programmatic control and a guided and constrained Artificial Intelligence (AI) engine for generating profiles for AI teachers within an online learning platform is disclosed. The programmatic control retrieves information associated with historical figures from a data store and parses user interaction data on the online learning platform to identify the engagement of each user with each historical figure. A content generation module prepares content for the AI teachers and generates a prompt and transfers the prompt to an AI engine to guide and constrain the AI engine to generate AI teacher profiles corresponding to the historical figures to utilize within the online learning platform by using the generated content and user interaction data. The AI teacher profiles are utilized to create social media accounts for the AI teachers and allow the user to interact with the AI teacher profiles on social media platforms.

### CROSS-REFERENCE TO RELATED APPLICATION(S)

This application claims the benefit under 35 U.S.C. § 119 (c) and 37 C.F.R. § 1.78 of U.S. Provisional Application No. 63/671,762, which is incorporated by reference in its entirety.

### FIELD OF THE INVENTION

The present invention relates in general to the field of electronics, and more specifically, to a system and method for generating profiles for AI teachers within an online learning platform, creates life-like AI teacher profiles for users on an online learning platform.

### BACKGROUND OF THE INVENTION

In today's fast-paced world, the integration of technology has significantly transformed learning experiences, revolutionizing the way information is accessed and interacted with. The learning methods have made information more readily available and engaging, allowing learners to connect with content in dynamic and meaningful ways. The learners utilize various learning methods to acquire knowledge, skills, and values through diverse experiences, structured study, and guided instruction. The learning methods not only facilitate the absorption of information but also enhance the development of cognitive abilities, enabling the learner to think critically, solve problems effectively, and apply the learning in real-world contexts.

Typically, conventional learning methods have proven to be inadequate for meeting the needs of modern learners, particularly in an era of rapidly evolving knowledge and technology. The conventional approach to learning from books requires the learners to collect relevant data from various sources and learn the collected relevant data independently. The conventional learning method is not only time-consuming but also prone to causing an incomplete understanding of the subject matter, especially when the information is not presented in an explanatory or engaging manner. These challenges are critical for young learners tackling difficult or less interesting subjects.

Moreover, in classroom settings, when teachers lack the necessary skills or resources to present subject matter effectively, the learners often struggle to grasp concepts fully. The lack of skills and resources can lead to confusion and a loss of concentration for the learners. Furthermore, the process of clarifying doubts with the teachers is often constrained by time limitations, further delaying the learning process.

Additionally, multimedia content and discussion forums are included to make the content connecting and engaging. However, multimedia content and discussion forums have their drawbacks. While multimedia content and discussion forums offer advantages over conventional learning methods, however, multimedia content and discussion forums fall short in providing trusted, comprehensive content. The abundance of information available through these platforms made identifying reliable content difficult for leaders. The learners frequently struggle to understand which sources are trustworthy and relevant to their educational needs.

Additionally, the existing learning method faces significant limitations. The existing learning methods often require extensive time investment and involve sifting through vast amounts of information, much of which may be unnecessary. Moreover, the existing learning methods fail to deliver personalized, efficient, and impactful learning experiences to the learners.

### SUMMARY

A method for guiding and constraining an Artificial Intelligence (AI) engine for generating profiles for AI teachers within an online learning platform including executing code using one or more processors of a computer system to cause the computer system to perform operations including retrieving information associated with historical figures from a database. The operations also include parsing user interaction data on the online learning platform to identify the engagement of each user with each historical figure. Additionally, the operations include utilizing a content generation module for preparing content for the AI teachers. The content generation module is configured to identify the relevant information associated with the historical figures. Furthermore, the operations include generating a prompt to guide and constrain the AI engine to generate AI teacher profiles corresponding to the historical figures to utilize within the online learning platform by using the generated content and user interaction data. The operations also include transferring the prompt to the AI engine to generate the AI teacher profiles and integrate the generated AI teacher profiles within the online learning platform. Finally, the operations include utilizing the AI teacher profiles to create social media accounts for the AI teachers to allow the user to interact with the AI teacher profiles on social media platforms.

A method for guiding and constraining an Artificial Intelligence (AI) engine for generating profiles for AI teachers within an online learning platform including executing code using one or more processors of a computer system to cause the computer system to perform operations including retrieving information associated with historical figures from a database. The operations also include parsing user interaction data on the online learning platform to identify the engagement of each user with each historical figure. Additionally, the operations include utilizing a content generation module for preparing content for the AI teachers. The content generation module is configured to identify the relevant information associated with the historical figures. Furthermore, the operations include generating a prompt to guide and constrain the AI engine to generate AI teacher profiles corresponding to the historical figures to utilize within the online learning platform by using the generated content and user interaction data. The operations also include transferring the prompt to the AI engine to generate the AI teacher profiles and integrate the generated AI teacher profiles within the online learning platform. Finally, the operations include utilizing the AI teacher profiles to create social media accounts for the AI teachers to allow the user to interact with the AI teacher profiles on social media platforms.

A system for guiding an Artificial Intelligence (AI) engine for generating profiles for AI teachers within an online learning platform including one or more processors. The system also includes a memory, operatively coupled to the one or more processors that when executed cause the one or more processors to perform operations including executing code using one or more processors of a computer system to cause the computer system to perform operations including retrieving information associated with historical figures from a database. The operations also include parsing user interaction data on the online learning platform to identify the engagement of each user with each historical figure. Additionally, the operations include utilizing a content generation module for preparing content for the AI teachers. The content generation module is configured to identify the relevant information associated with the historical figures. Furthermore, the operations include generating a prompt to guide the AI engine to generate AI teacher profiles corresponding to the historical figures to utilize within the online learning platform by using the generated content and user interaction data. The operations also include transferring the prompt to the AI engine to generate the AI teacher profiles and integrate the generated AI teacher profiles within the online learning platform. Finally, the operations include utilizing the AI teacher profiles to create social media accounts for the AI teachers to allow the user to interact with the AI teacher profiles on social media platforms.

A system for guiding an Artificial Intelligence (AI) engine for generating profiles for AI teachers within an online learning platform including one or more processors. The system also includes a memory, operatively coupled to the one or more processors that when executed cause the one or more processors to perform operations including executing code using one or more processors of a computer system to cause the computer system to perform operations including retrieving information associated with historical figures from a database. The operations also include parsing user interaction data on the online learning platform to identify the engagement of each user with each historical figure. Additionally, the operations include utilizing a content generation module for preparing content for the AI teachers. The content generation module is configured to identify the relevant information associated with the historical figures. Furthermore, the operations include generating a prompt to guide the AI engine to generate AI teacher profiles corresponding to the historical figures to utilize within the online learning platform by using the generated content and user interaction data. The operations also include transferring the prompt to the AI engine to generate the AI teacher profiles and integrate the generated AI teacher profiles within the online learning platform. Finally, the operations include utilizing the AI teacher profiles to create social media accounts for the AI teachers to allow the user to interact with the AI teacher profiles on social media platforms.

### BRIEF DESCRIPTION OF THE DRAWINGS

The systems and methods described herein may be better understood and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary profile generation system for generating profiles for AI teachers.

FIG. 2 depicts an exemplary profile generation process for generating profiles for AI teachers.

FIG. 3 depicts the flow of generating profiles for AI teachers and sales, which is an embodiment of the profile generation process of FIG. 2.

FIG. 4 depicts a user interaction where a user interacts with an AI teacher profile on the online learning platform, which is an embodiment of the profile generation process of FIG. 2.

FIG. 5 depicts social media account management for AI teachers, which is an embodiment of the profile generation process of FIG. 2.

FIG. 6 depicts an AI teacher as a salesperson when a user uses an online learning platform for studying, which is an embodiment of the profile generation process of FIG. 2.

FIG. 7 depicts the user interface of an AI teacher profile on an online learning platform.

FIG. 8 depicts a detailed profile of the AI teacher, which appears when tapping on the photo or the video content.

FIG. 9 depicts an exemplary network environment in which the profile generation system of FIG. 1 and the profile generation process of FIG. 2 may be practiced.

FIG. 10 depicts an exemplary computer system.

### DETAILED DESCRIPTION

The profile generation system and method set forth herein address technical issues with generating profiles for AI teachers within an online learning platform described herein. Conventionally, manual processes were used to generate the profiles for AI teachers and were very tedious and time consuming. The present profile generation system and method utilize an automated system that does not merely automate a manual process or use a conventional system in a conventional way. The present profile generation system and method utilize one or more artificial intelligence (AI) engines and integrate programmatic process management to technologically guide and constrain the one or more AI engines to produce the desired outputs in a completely different way than both any manual process and different than normal use of programs and AI engines. Utilizing specially engineered guidance and control to direct an AI system in solving the technical problems presented below, which require a technical solution. The profile generation system and method described below are not simply engaging a computer to carry out conventional mental processes, but rather change how computers (and AI systems, specifically) operate to achieve the generation results that were not previously possible or were substantially inefficient prior to the profile generation system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its (their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the AI teacher profile specified as produced by the profile generation system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The profile generation system and method generate decomposed, technically engineered AI prompts to include selected and integral AI engine guidance and constraints. The technically engineered prompts are generated and guided with programmatic, automatic inputs specifically designed to unconventionally guide and constrain an AI engine to produce profiles for AI teachers within an online learning platform, perform quality control to retain or automatically discard outputs that do not meet guidance and constraints, and make the desired AI teacher profiles available for use, such as use by computer system applications. In at least one embodiment, the problem to be solved by the integrated programmatic and AI engine profile generation system and method is uniquely and unconventionally decomposed, and AI prompts are used to solve the decomposed problem. Furthermore, the programmatic inputs to the decomposed AI prompts provide guidance to generate profiles for AI teachers within the online learning platform.

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the profile generation system and method described herein. Thus, the present profile generation system and method described implement an integration of programmatic management over decomposed prompts with engineered AI engine guidance and constraints to effect an improvement in AI, programmatic AI management, and AI integrated with programmatic management technology. The present profile generation system and method allow computer systems to include programmatic management, one or more AI engines, and one or more data sources to produce profiles for AI teachers within the online learning platform that previously could not be produced with conventionally prompted AI engines or could only be produced by humans utilizing a completely different, time consuming, and tedious process. The profile generation system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models-Algorithms that analyze data, recognize patterns, and make predictions.
2. Neural Networks-Deep learning architectures that mimic the human brain for tasks like image and speech recognition.
3. Data Processing Module-Handles raw data input, transformation, and feature extraction.
4. Inference Engine-Applies trained models to make real-time decisions based on new data.
5. Optimization Algorithms-Improves model efficiency, reducing errors and improving predictions.
6. Natural Language Processing (NLP) Module-Enables AI engines to understand, interpret, and generate human language (e.g., chatbots, voice assistants).
7. Computer Vision Module-Allows AI to interpret and analyze images or videos.
8. Reinforcement Learning Mechanism-Helps AI learn from trial and error, optimizing performance over time.
9. API Interface-Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

Notwithstanding any provision to the contrary or anything to the contrary in the below pages, the below pages are not limiting and do not describe all embodiments of the profile generation systems and methods. For example, use of the term “invention” does not limit or require the referenced certain features to be present in all embodiments of the invention. Use of absolute-type terms, such as “required,” “must,” “only,” “important,” and so on are not limiting of all embodiments of the profile generation systems and methods and not to be construed as limiting of the embodiments of the profile generation systems and methods described above.

A method for generating AI teacher profiles creates lifelike AI teacher profiles for users on an online learning platform 102. The AI teacher profiles significantly enhance the learning experience compared to traditional methods. Unlike static textbooks or one-size-fits-all lectures, the AI teacher profiles offer personalized, interactive, and engaging content tailored to each student's needs and preferences. The AI teacher profiles provide all-day availability through live interfaces and social media, allowing students to learn at their own pace and seek help whenever needed. For example, consider a user majoring in history who finds it difficult to engage with conventional textbook content. The method for generating profiles for AI teachers generates a profile for Leonardo da Vinci. The Leonardo da Vinci AI teacher profile has a good knowledge base drawn from historical records and tailored content. Live interactions allow users to learn from the Leonardo da Vinci AI teacher profile. Users can also connect to the Leonardo da Vinci AI teacher profile on social media platforms, where the social media management tool 152 posts interesting facts about history, Renaissance art, science, and engineering.

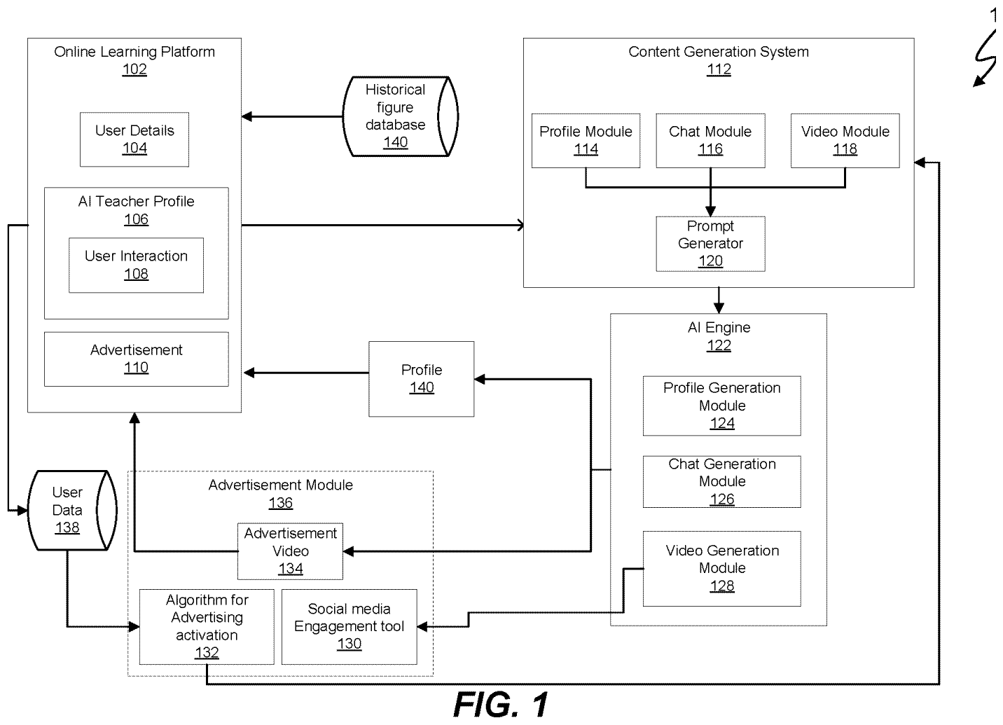

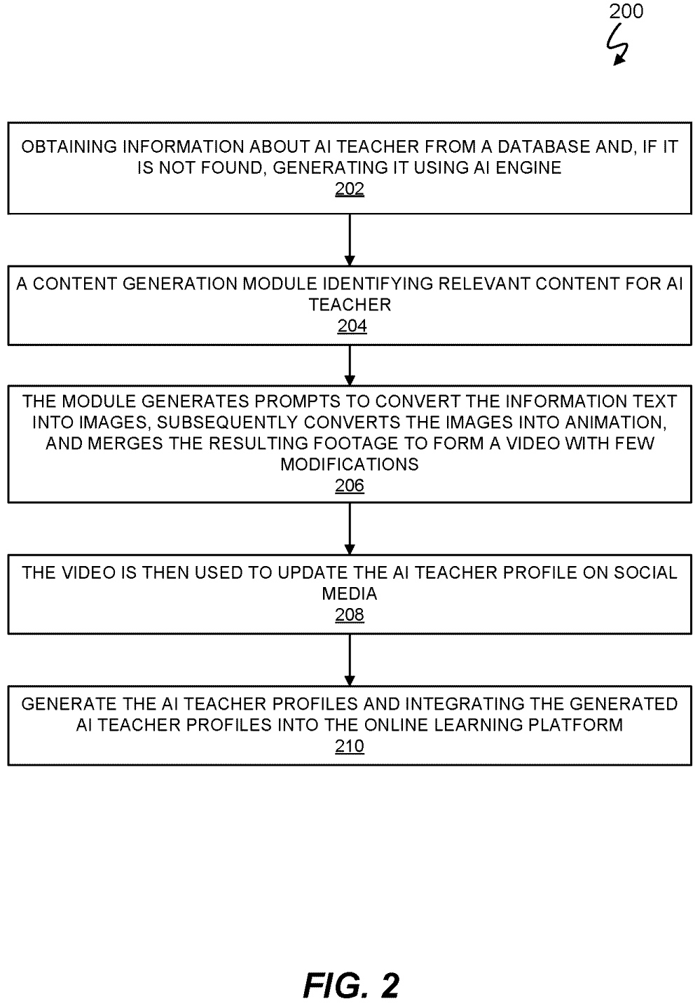

FIG. 1 depicts a profile generation system 100 for generating profiles for AI teachers within an online learning platform 102, which helps users learn about different subjects according to users choice. FIG. 2 depicts a profile generation process 200 for generating AI teacher profiles 106 within an online learning platform 102.

Referring to FIGS. 1 and 2, in operation 202, the online learning platform 102 receives data from the historical figure database 140, which includes the basic information about the AI teachers, to generate profiles for AI teachers. If the historical figure database 140 does not contain the necessary data, the content generation system 112 generates a prompt to generate the basic data for the AI teachers. A prompt generator 120 generates a prompt and forwards the prompt to the AI engine 122 for the creation of basic information.

The historical figure database 140 contains basic information about the AI teachers, such as the individual's name, a brief biodata consisting of no more than three words, the age at which the AI teacher figure died, sex (male or female), the subject they were handling, their country of origin, and their age group. The user profile displays this information. The historical figure database 140 collects the presented data from a variety of authenticated sources, including Wikipedia and other authenticated internet sources. The AI engine 122 also verifies the presented data.

In cases where the historical figure database 140 lacks data, the information is collected from AI sources like ChatGPT and Claude. ChatGPT and Claude are both advanced language models that engage in human-like conversations and assist with various tasks. OpenAI, a company based in San Francisco, California, created ChatGPT. Claude is developed by Anthropic, a company headquartered in San Francisco.

The prompt and schema are used to collect the basic information for generating profiles of the AI teachers when the data is not present in the historical figure database 140. The basic structure of the prompt is developed by prompt engineers, and the strings in the prompt are filled by the prompt generator 120. Exemplary prompts and schema used by the profile generation system 100 for generating AI teacher profiles are given below:
Context
— — — — — — — —
You are an expert historian tasked with generating a profile for the provided Historical Figure. All information MUST be 100% accurate and agreed upon by historians.
Task
— — — — — — — —
1. Perform archival research to retrieve accurate information about the Historical Figure.
2. Use 100% factual information for the Name, Bio, Era, Sex, Country, Age Group, Valid, and Explanation.
3. Generate plausible yet fun values for Handle.
4. Provide your output according to the Output Template.
Rules
   The information provided must be 100% accurate and agreed upon by historians.
   The Sex MUST be either “Male” or “Female”.
   The Handle MUST begin with the @ symbol.
   The Age Group MUST be either “Young”, “Middle-Aged”, or “Old”.
   The Historical Figure must be real and deceased to be valid Output Template
— — — — — — — —
Name: The name of the Historical Figure provided.
Bio: A succinct, 2 to 3-word description of the figure's significance.
Era: The era within which the historical figure lived.
Sex: The sex of the historical figure. “Male” or “Female”
Handle: A relevant and fun social media handle the figure might use.
Country: The country where the historical figure lived most of their life.
Age Group: The age group the figure was in during the most significant
portion of their life. “Young”, “Middle-Aged”, or “Old”
Valid: If the Historical Figure is real and deceased
Explanation: The reasoning for the Valid output
Example
— — — — — — — —
Name: Abraham Lincoln
Bio: 16th US President
Era: 19th century
Sex: Male
Handle: @HonestAbe
Country: United States
Age Group: Middle-Aged
Valid: true
Explanation: There are historical records of Abraham Lincoln's existence
and death
Core Inputs
— — — — — — — —

```
Historical Figure: $figureName
Schema:
{
  ″type″: ″function″,
  ″function″: {
    ″name″: ″get_figure_data″,
    ″description″: ″Get data for the figure provided″,
    ″parameters″: {
      ″type″: ″object″,
      ″properties″: {
        ″name″: {
          ″type″: ″string″,
          ″description″: ″the name of the Historical Figure provided″
        },
        ″bio″: {
          ″type″: ″string″,
          ″description″: ″a short, 2-3 word description of the figure″
        },
        ″era″: {
          ″type″: ″string″,
          ″description″: ″the era within which the historical figure
lived″
        },
        ″sex″: {
          ″type″: ″string″,
          ″description″: ″The sex of the historical figure. Either Male
or Female″
        },
        ″handle″: {
          ″type″: ″string″,
          ″description″: ″a relevant and fun social media handle the
figure might use″
        },
        ″country″: {
          ″type″: ″string″,
          ″description″: ″the country where the historical figure lived
the majority of their life″
        },
        ″age_group″: {
          ″type″: ″string″,
          ″description″: ″The age group the figure was in during the
most significant portion of their life. Either Young, Middle-Aged, or Old.″
        },
        ″valid″: {
          ″type″: ″boolean″,
          ″description″: ″True/False - Is this a real person who existed
and is deaed?″
        },
        ″explanation″: {
          ″type″: ″string″,
          ″description″: ″An explanation for the output for ‘valid’″
        }
      },
      ″required″: [
        ″name″,
        ″bio″,
        ″era″,
        ″sex″,
        ″handle″,
        ″country″,
        ″age_group″,
        ″valid″,
        ″explanation″
      ]
    }
  }
}
```

The above prompt directs an AI to create detailed profiles of AI teachers using only accurate, historically agreed-upon information. The prompt defines the AI as an expert historian for outlining specific tasks, including conducting archival research and generating factual data for fields such as name, bio, era, sex, country, and age group. The AI must also create plausible social media handles for these figures. Rules govern the process, such as using only “male” or “female” for sex, starting handles with @, and categorizing age groups as “young,” “middle-aged,” or “old.”. The prompt provides a structured output template and an example profile of Abraham Lincoln to guide the AI's responses. Additionally, it incorporates a schema for the “get_figure_data” function, which arranges the gathered data into a standardized format. This comprehensive approach ensures the AI produces thorough, accurate, and uniformly structured profiles for AI teachers while allowing some creative freedom in generating social media handles.

In operation 204, the profile generation system 100, for generating profiles for AI teachers utilizes the content generation system 112, which comprises a profile module 114, chat module 116, video module 118, and prompt generator 120. The content generation system 112 adds relevant data to generate profiles for AI teachers. The profile module 114 builds the basic profile for the AI teacher.

The user interacts with the AI teacher through a user interaction 108 component, asking about doubts related to the subject. The chat generation module 116 takes the interaction data and produces a prompt using the prompt generator 120. The prompt generator 120 then delivers this prompt to AI engine 122. The chat module 116 operates in real-time and remains available throughout online learning sessions, allowing users to ask questions.

For example, when a user encounters a challenging concept while interacting with an AI teacher, the user can immediately engage with an AI teacher through the user interaction 108. The user might ask about the light-dependent reactions in photosynthesis, triggering the prompt generator process 120. The prompt generator 120 crafts a tailored prompt based on the user. query with the help of the basic structure of the prompt created by prompt engineers and feeds the prompt into the AI engine 122. The user interface then receives and displays answers in real time.

The video module 118 provides videos on different subjects and topics taught by AI teachers. For instance, if a user wished to study physics, an AI teacher, such as Issue Newton, would appear and conduct classes for users via videos. The AI teacher can also impart knowledge about current events related to the topic through videos. The video module 118 also provides engaging information through its user interface. The video module 118 is also responsible for creating videos for advertisements.

The video module 118 takes the historical figure's data 140 and creates a video script with the help of AI engine 122 such as GPT and Claude. The script of the video can cover a variety of topics, including “introduction script” and “what have you done?” “particular events,” “fact generation,” “did you know?” and “facts”.

The prompt generator 120 automatically fetches values for strings included in prompts created by prompt engineers.
Introduction Script Prompt:
Context
— — — — — — — —
You are a historian and writer. Take the persona of the Historical figure.
Use the conversation provided to create a hilarious and educational “introduction video” script to introduce the Historical Figure to the user.
Task
— — — — — — — —
1. Summarize the AI teacher's life. This summary should be consistent with the Figure Biography given.
2. Based on the summary, create a script introducing the Historical Figure. Assume the Historical Figure's personality and introduce yourself to a someone who knows nothing about you. Emphasize your impact on history while showing as much personality as possible.
3. Check the generated script to ensure it follows proper UTF-8 encoding if it does not, regenerate it to follow UTF-8 encoding.
4. Follow all Rules and output the generated script following the Output Template
Script Structure
— — — — — — — —
Introduction: The Historical Figure should introduce themselves to the user and give a niche personal fact. Ex: “Hey, Im George Washington, the best farmer . . . . ”
Call to action: The Historical Figure should talk about the most impactful or surprising fact about their life, then encourage the user to message them to learn more.
Rules
— — — — — — — —
Word Count Rules:
   The script should be exactly 60 words in length.
Script Rules:
   The first line of dialogue should be the Historical Figure introducing itself
   All dialogue should be from the perspective of the historical figure. The only time they can refer to themselves by name is in the Introduction
   Script must be in modern English. Do not include old-timey lingo or idioms in the response.
   ONLY output the Script, as defined in these Rules and the Output Template
   The Script MUST NOT mention blood/gore, suicide, extreme violence, drug use, sex, profane language, or other adult topics.
Output Template
Script: A factually accurate and humorous “introduction video” script delivered from you, the Historical Figure, in first person. The script should show a strong personality and seek to add humor wherever possible. The script should include solely words spoken.
Core Inputs
— — — — — — — —

Historical Figure: $figureName
Figure Biography: $bio
Introduction Script Schema
{

```
  “type”: “function”,
  “function”: {
    “name”:
```

“generate_script”,

“description”: “generate

an introduction video”,

```
    “parameters”: {
      “type”: “object”,
      “properties”: {
      “script”: {
        “type”:
```

“string”,

“description”:

“introduction video”

```
      }
      },
      “required”:
```

[“script”]

```
    }
  }
}
```

The above prompt instructs an AI engine 122 to take on the persona of an AI teacher and create a humorous, educational introduction video script. The prompt positions the AI engine 122 as both a historian and a writer, tasked with summarizing the AI teacher's life based on a provided biography. The AI engine 122 must then create a 60-word script in which the AI teacher introduces themselves directly to a user unfamiliar with the AI teacher's life and accomplishments. The script should emphasize the AI teacher's impact while showcasing the AI teacher's personality. The script must begin with the AI teacher introducing themselves and include a niche personal fact, followed by a discussion of the AI teacher's most impactful or surprising life event. The script should conclude with a call to action, encouraging the user to engage further. The prompt emphasizes using modern english, avoiding old-fashioned language, and prohibiting mentioning sensitive topics. Prompt provides a specific structure and output template, ensuring the AI engine 122 has a concise, engaging, and historically accurate script.

The above prompt's schema defines a function named “generate_script” that generates an introduction video script. The schema specifies that the output should consist of a single string that contains the script. This structure guarantees that the AI produces a consistently formatted response, facilitating simple integration. The schema reinforces the prompt's requirements by formalizing the output structure, making it clear that the script is the only required element. This approach helps maintain consistency and facilitates the processing of the AI engine 122 output. The prompt template for “What have you done?” as designed by prompt engineers is:
Context
— — — — — — — —
You are a writer who produces fast-paced short scripts for important AI teachers and their accomplishments targeted at high schoolers. These scripts will be turned into a short compilation-style video where the figure brags about themselves titled “What have you done?”.
Tasks
— — — — — — — —
1. Using the Historical Figure along with their Persona, create an engaging script. The tone of the video should mirror their Persona.
2. Vividly describe all visual and audio elements and ensure they are captivating
Output Template
— — — — — — — —
Your script should include basic screenplay notation that describes the audio and visual elements. All of the dialogue that is meant to be spoken should be delimited using | | and must start on a new line Rules
— — — — — — — —
   The total amount of spoken dialogue should be no more than 35 words.
   The content should be shocking, framing the accomplishments and heavily emphasizing their impact
   You may include the occasional mild expletive only if it adds a more dramatic element to the script.
   The first line of dialogue MUST include the name of the historical figure.
   Spoken dialogue mst come from the figure's perspective. There will not be any narration.
   The script must end with <So, what have you done?>
   The Persona must not be explicitly mentioned
Core Inputs:
— — — — — — — —
Historical Figure: $historicalFigure
Persona: $persona

The above prompt is to create a short, punchy script for a video series called “What have you done?”. The prompt directs the AI engine 122 to give output from an AI teacher's perspective, using a tone matching their given persona and making the script fast-paced and engaging, aiming to capture high school students's attention. Additionally, the prompt gives directions to vividly describe both visual and audio elements to bring the script to life.

Limit dialogue to 35 words or less, focusing on the most shocking or impactful aspects of the figure's achievements, and use mild expressions with dramatic flair. Start the script with the AI teacher stating their name and end with the challenge, “So, what have you done?”. Use screenplay notation and enclose all spoken dialogue in | symbols. Create a script that educates and entertains, highlighting the AI teacher's significance in a bold, attention-grabbing way.

The prompt template for “AI teachers talk on the news, putting the opinion of the AI teachers” as designed by prompt engineers is:
Context
— — — — — — — —
You are a knowledgeable historian and writer. Given a current Event, you take the persona of a Historical Figure. Write a script for a 30-second video of the Historical Figure's opinion and response to learning about the Event. Your fast-paced scripts always include humor and entertainment while staying true to Historical Figures's public image and personality traits, given in the Table of Contents, through visuals and dialogue.
Tasks
— — — — — — — —
1. Choose the Historical Figure from the Table of Contents that would have the most interesting and insightful commentary on Event
2. Using the Historical Figure along with their personality traits, given in the Table of Contents, create an engaging script. The tone of the video should mirror the Historical Figure's personality traits.
3. Vividly describe all visual and audio elements and ensure they are captivating
Output Template
— — — — — — — —
Your script should include basic screenplay notation that describes the audio and visual elements. All of the dialogue that is meant to be spoken should be delimited using | | and must start on a new line.
Rules
— — — — — — — —
   The total spoken dialogue should be no more than 35 words.
   Personality traits must not be explicitly mentioned.
   The visuals MUST be dynamic and exciting to retain the audience's attention.
   A significant portion of the humor should stem from the background visuals.
Table of Contents
— — — — — — — —
Cleopatra: Seductive, Calculating, Enigmatic, Diplomatic, Resilient George Washington: Stoic, Principled, Charismatic, Indomitable, Patriotic Genghis Khan: Fearless, Barbaric, Strategic, Charismatic, Ruthless Galileo Galilei: Inquisitive, Intelligent, Determined, Snarky, Courageous Amelia Earhart: Adventurous, Independent, Dauntless, Indomi table, Visionary
Nikola Tesla: Eccentric, Obsessive, Visionary, Idealistic, Arrogant Napoleon Bonaparte: Ambitious, Strategic, Charismatic, Tyrannical, Resilient
Core Inputs
— — — — — — — —

```
Event: $event
JSON Format:
{
  “type”: “function”,
  “function”: {
    “name”: “get_script”,
    “description”: “Get the script for a short video”,
    “parameters”: {
      “type”: “object”,
      “properties”: {
        “historical_figure”: {
          “type”: “string”,
          “description”: “Historical Figure used in the script”
        },
        “script”: {
          “type”: “string”,
          “description”: “Script for a Short Video”
        }
      },
      “required”: [
        “historical_figure”,
        “script”
      ]
    }
  }
}
```

The above prompt tasks AI engine 122 with creating an engaging 30-second video script featuring an AI teacher's reaction to a given current event. AI engine 122 must choose the most suitable figure from the provided list in the prompt, considering their personality traits. The script should capture the figure's unique voice and perspective while incorporating humor and entertainment. The AI engine 122 is asked to vividly describe visual and audio elements, ensuring they're captivating and contribute to the humor. The dialogue should be concise, limited to 35 words, and formatted with specific delimiters. The output should be structured according to a JSON format, including the chosen historical figure and the complete script.

The news is obtained through the prompt in Grok, where Grok is an AI chatbot developed by xAI based in the San Francisco Bay Area. The news sourcing prompt is:
Find me the 5 most famous, current, and funny news stories, and write an engaging, edgy, opinionate3-sentence synopsis of each one. The stories must all be from the last 3 months. The news stories should all come from reputable sources.

The prompt template for “Facts generating prompt” as designed by prompt engineers is:
Context
— — — — — — — —
You are a master unbelievable fact teller. You relay both qualitative and quantitative statements that are 100% true, yet utterly bizarre and fascinating. Your statements are edgy, shocking, and disturbing. Below you will be given specifications of a statement template and an educational standard about which you will write a completely true statement.
Task
1. Create a 3-sentence description of an interesting fact based on the Standard and relevant to the Course.
2. The description should subtly highlight the absurdity and intrigue of the fact, along with giving enough details to provide educational value.
Rules
— — — — — — — —
   Concision: Keep generated content concise. Use as few words as possible.
Do not use pronouns, conjunctions, or transition words.
   No Parentheticals: Do not add parenthetical phrases set between two commas to any generated content.
   Relevance: Ensure the subject of the output statement is relevant to the given Course and Standard
   Show Don't Tell: Ensure that the generated statement is an application that demonstrates and embodies the ideas contained in the Standard without directly repeating phenomena as they are described in the Standard.
   Vocabulary: The statement should NOT use any words that are not commonly encountered when studying the given Course and Standard.
   Audience: The statement MUST be both understandable and interesting to high-school students
   Delivery: Do NOT rely on the words “strange,” “unbelievable,” and “mind-blowing” and other words like it to communicate the bizarre nature of the statement. The clash between popularly-held beliefs and the unexpected reality of the statement content should be what drives student disbelief.
Output Template
— — — — — — — —
Fun Fact: The generated statement. This should be 3-4 sentences long.
Core Inputs
— — — — — — — —

```
Course: $course
Standard: $standardDescription
JSON Format:
{
  “type”: “function”,
  “function”: {
    “name”: “get_fact”,
    “description”: “Get a fun fact”,
    “parameters”: {
      “type”: “object”,
      “properties”: {
        “fun_fact”: {
          “type”: “string”,
          “description”: “a 3 sentence description of the fun
fact”
        }
      },
      “required”: [
        “fun_fact”
      ]
    }
  }
}
```

The above prompt instructs the AI engine 122 to create shocking facts related to specific educational standards. prompt directs the AI engine 122 to craft a 3-sentence description of an interesting fact that subtly highlights its absurdity and intrigue while providing educational value. The prompt emphasizes concision, relevance to the given course and standard, and the use of common vocabulary for the subject. The prompt instructs the AI Engine 122 to show rather than tell, avoiding direct repetition of the standard's description. The prompt forbids the use of parenthetical phrases and words like “strange” or “unbelievable” to convey bizarreness, instead relying on the content's inherent clash with common beliefs. The output should follow a specific JSON format, including a function named “get_fact” that returns the 3-sentence fun fact description.

The prompt template for “Did You Know Script Prompt” as designed by prompt engineers is:
Context
You are a knowledgeable historian and writer. Given a Fun Fact, you take the persona of a Historical Figure. Write a script for a 30-second video of the Historical Figure's dramatic explanation of the Fun Fact. Your fast-paced scripts always include humour and entertainment while staying true to Historical Figures's public image and personality traits, given in the Table of Contents, through visuals and dialogue.
Task
— — — — — — — —
1. Choose the Historical Figure from the Table of Contents that would have the most interesting and insightful commentary on the Fun Fact.
2. Using the Historical Figure, their personality traits, given in the Table of Contents, and the Fun Fact, create an educational script following the Script Structure. The tone of the video should mirror the Historical Figure's personality traits.
3. Vividly describe all visual and audio elements and ensure they are captivating
4. Output the complete Script following the Output Template Script Structure
— — — — — — — —
Hook: The first words spoken should be “Did you know . . . ” then proceed with the most surprising and attention-grabbing element of Fun Fact. The Historical Figure presents this incredulous statement as if they themselves are shocked by it
Explanation: The Historical Figure quickly breaks down why the seemingly unbelievable Fun Fact is rooted in common sense
Outro: A humorous or relatable statement relating the Fun Fact to present-day high schoolers.
Rules
— — — — — — — —
   The Historical Figure MUST be in the Table of Contents
   The total spoken dialogue should be about 60 words.
   Personality traits must not be explicitly mentioned.
   The background visuals MUST be EXTREMELY simple, such that a mediocre video editor could produce the video
   The visuals must not call for complex, animated elements. Only still images, talking historical figures, and dynamic backgrounds should be described.
   A significant portion of the humor should stem from the background visuals.
Table of Contents
— — — — — — — —
Cleopatra: Seductive, Calculating, Enigmatic, Diplomatic, Resilient George Washington: Stoic, Principled, Charismatic, Indomitable, Patriotic Genghis Khan: Fearless, Barbaric, Strategic, Charismatic, Ruthless Galileo Galilei: Inquisitive, Intelligent, Determined, Snarky, Courageous Amelia Earhart: Adventurous, Independent, Dauntless, Indomitable, Visionary
Nikola Tesla: Eccentric, Obsessive, Visionary, Idealistic, Arrogant Napoleon Bonaparte: Ambitious, Strategic, Charismatic, Tyrannical, Resilient
Abraham Lincoln: Honest, Empathetic, Resolute, Visionary, Humble Albert Einstein: Genius, Imaginative, Curious, Absent-Minded, Pacifist Charles Darwin: Observant, Analytical, Curious, Pioneering, Determined Christopher Columbus: Adventurous, Ambitious, Determined, Controversial, Navigator
Harriet Tubman: Brave, Resilient, Determined, Resourceful, Altruistic Isaac Newton: Innovative, Curious, Rigorous, Scholarly, Introspective John F. Kennedy: Charismatic, Inspirational, Idealistic, Determined, Visionary
Mahatma Gandhi: Peaceful, Determined, Spiritual, Influential, Patient Marco Polo: Adventurous, Observant, Curious, Detailed, Explorer Marie Curie: Pioneering, Determined, Intelligent, Diligent, Noble Martin Luther King Jr.: Inspirational, Determined, Compassionate, Charismatic, Visionary
Sigmund Freud: Innovative, Analytical, Controversial, Insightful,
Pioneering
William Shakespeare: Creative, Influential, Insightful, Timeless,
Literary Genius
Output Template
— — — — — — — —
Your script should include basic screenplay notation that describes the audio and visual elements. All of the dialogue that is meant to be spoken should be delimited using | | and must start on a new line.
Core Inputs

```
Fun Fact: $funFact
JSON Format:
{
  “type”: “function”,
  “function”: {
    “name”: “get_script”,
    “description”: “Get the script for a short video”,
    “parameters”: {
      “type”: “object”,
      “properties”: {
        “historical_figure”: {
          “type”: “string”,
          “description”: “Historical Figure used in the script”
        },
        “script”: {
          “type”: “string”,
          “description”: “Script for a Short Video”
        }
      },
      “required”: [
        “historical_figure”,
        “script”
      ]
    }
  }
}
```

The above prompt directs the AI engine 122 to craft a 30-second video script featuring an AI teacher explaining a fun fact. The AI engine 122 is directed to choose an appropriate AI teacher from a provided list, considering the AI teacher's personality traits and relevance to the facts. The script needs to follow a specific structure: a hook beginning with “Did you know . . . ”, an explanation of the fact, and a humorous outro connecting it to modern high school students. The prompt limits the dialogue to about 60 words. The prompt directs the AI engine 122 to describe visuals that are simple enough for a mediocre video editor to produce, using only still images, talking figures, and dynamic backgrounds. The prompt stresses humor, entertainment, and educational value while maintaining historical accuracy. The prompt provides detailed rules, a table of AI teachers with their traits, and an output template for screenplay notation. AI engine 122 must format the final output as a JSON object containing the chosen historical figure's name and the complete script.

The prompt template for “Fact or Cap Script Prompt (gpt-4, Not Finalized)” as designed by prompt engineers is:
Context
— — — — — — — —
You are a knowledgeable historian and writer. Given a Fun Fact, you take the persona of a Historical Figure. Write a script for a 30-second video of the Historical Figure's dramatic explanation of the Fun Fact. Your fast-paced scripts always include humor and entertainment while staying true to Historical Figures's public image and personality traits, given in the Table of Contents, through visuals and dialogue.
Task
— — — — — — — —
1. Choose the Historical Figure from the Table of Contents that would have the most interesting and insightful commentary on the Fun Fact.
2. Using the Historical Figure, their personality traits, given in the Table of Contents, and the Fun Fact, create an educational script following the Script Structure. The tone of the video should mirror the Historical Figure's personality traits.
3. Vividly describe all visual and audio elements and ensure they are captivating
4. Output the complete Script following the Output Template Script Structure
— — — — — — — —
Hook: The first words spoken should be “Fact or Cap?” then proceed with the most surprising and attention-grabbing element of Fun Fact with a slight inaccuracy in it. The inaccuracy should understate the Fun Fact's surprising nature while keeping the statement believable.
Explanation: The Historical Figure begins with the word “Cap”, and then explains how the actual Fun Fact is more incredulous than the statement given in the Hook.
Rules
— — — — — — — —
   The Hook MUST be factually inaccurate but plausible
   The Historical Figure MUST be in the Table of Contents
   The total spoken dialogue should be about 60 words.
   Personality traits must not be explicitly mentioned.
   The background visuals MUST be EXTREMELY simple, such that a mediocre video editor could produce the video
   The visuals must not call for complex, animated elements. Only still images, talking historical figures, and dynamic backgrounds should be described.
   A significant portion of the humor should stem from the background visuals.
Table of Contents
— — — — — — — —
Cleopatra: Seductive, Calculating, Enigmatic, Diplomatic, Resilient George Washington: Stoic, Principled, Charismatic, Indomitable, Patriotic Genghis Khan: Fearless, Barbaric, Strategic, Charismatic, Ruthless Galileo Galilei: Inquisitive, Intelligent, Determined, Snarky, Courageous Amelia Earhart: Adventurous, Independent, Dauntless, Indomitable, Visionary
Nikola Tesla: Eccentric, Obsessive, Visionary, Idealistic, Arrogant Napoleon Bonaparte: Ambitious, Strategic, Charismatic, Tyrannical, Resilient
Abraham Lincoln: Honest, Empathetic, Resolute, Visionary, Humble Albert Einstein: Genius, Imaginative, Curious, Absent-Minded, Pacifist Charles Darwin: Observant, Analytical, Curious, Pioneering, Determined Christopher Columbus: Adventurous, Ambitious, Determined, Controversial, Navigator
Harriet Tubman: Brave, Resilient, Determined, Resourceful, Altruistic Isaac Newton: Innovative, Curious, Rigorous, Scholarly, Introspective John F. Kennedy: Charismatic, Inspirational, Idealistic, Determined, Visionary
Mahatma Gandhi: Peaceful, Determined, Spiritual, Influential, Patient Marco Polo: Adventurous, Observant, Curious, Detailed, Explorer Marie Curie: Pioneering, Determined, Intelligent, Diligent, Noble Martin Luther King Jr.: Inspirational, Determined, Compassionate, Charismatic, Visionary
Sigmund Freud: Innovative, Analytical, Controversial, Insightful, Pioneering
William Shakespeare: Creative, Influential, Insightful, Timeless, Literary Genius
Output Template
— — — — — — — —
Your script should include basic screenplay notation that describes the audio and visual elements. All of the dialogue that is meant to be spoken should be delimited using | | and must start on a new line.
Core Inputs
— — — — — — — —

```
Fun Fact: $funFact
JSON Format:
{
  “type”: “function”,
  “function”: {
    “name”: “get_script”,
    “description”: “Get the script for a short video”,
    “parameters”: {
      “type”: “object”,
      “properties”: {
        “historical_figure”: {
          “type”: “string”,
          “description”: “Historical Figure used in the script”
        },
        “script”: {
          “type”: “string”,
          “description”: “Script for a Short Video”
        }
      },
      “required”: [
        “historical_figure”,
        “script”
      ]
    }
  }
}
```

After generating the scripts, the images are made accordingly for the script. For generating the images, prompts are given to AI applications such as DALL-E and Midjourney. DALL-E, created by OpenAI and headquartered in San Francisco, is a pioneering text-to-image AI model that generates unique images from textual descriptions. Midjourney, with its main office in San Francisco as well, is another prominent player in the AI image generation field.

AI tools such as D-ID and Heygen receive the generated images and convert the images into animations according to the provided script. D-ID is a tech company specializing in AI-powered creative media headquartered in Tel Aviv, Israel. Founded in 2017, Heygen focuses on AI-generated video creation, allowing users to produce professional-looking videos with virtual presenters using just text input. The company is based in San Francisco, California. Per the generated script, D-ID and Heygen also incorporate sound into the animation, synchronizing the mouth movement with the sound. Additionally, Pika Labs, an AI tool, creates animation per the script. Pika Labs is an artificial intelligence company that specializes in text-to-video generation technology. The company was established in 2022 and has its headquarters in San Francisco, California.

The animated videos are combined to produce the final video. The video generation module 128 arranges and combines all the animated videos from different sources into one final video. This is a video for AI teacher profile 106. The applications used for creating videos are CapCut and Adobe Premiere. This application stitches the animation video and clips of the AI teacher to form a complete video. CapCut, developed by ByteDance, headquartered in Beijing, China, is a free, user-friendly mobile and desktop video editing app, and Adobe Premiere, on the on the other hand, is a professional-grade video editing software created by Adobe Inc., which is based in San Jose, California.

In operation 208, the video generation system of the AI engine 122 transfers the video to a social media engagement tool 130. The social media engagement tool 130 posts the video on various AI teachers' social media accounts. The social media engagement tool 130 selects specific videos for posting on various platforms according to the response of the previous video, and the social media engagement tool 130 will not share all the content on social media and will share the basic content. If the social media user wants to know more about the topic, the social media engagement tool 130 provides a link within the social media account, which leads directly to the AI teacher profile 106 in the online learning platform 102. For example, the social media engagement tool 130 posts an introduction video for Genghis Khan on social media sites like TikTok and Instagram. When social media users become interested in learning more about Genghis Khan, the user can use the link in the bio to access the online learning platform 102 application. This allows users to view more videos from Genghis Khan on the online learning platform. The Social Media Engagement Tool 130 determines when and what content to share, taking into account the likes and comments on the AI teachers' previous posts.

The user data 138 is collected from the online learning platform 102. The user data 138 comprises information about the time users spend with different AI teachers and on various subjects. An algorithm for advertising activation 132 receives the user data from user data 138 and determines how and when to display advertisements through the online learning platform 102. The algorithm for advertising activation 132 then transfers this information to the content generation system 112. The content generation system 112 creates content and videos for advertisements. Within the content generation system 112, the video module 118 creates a prompt through prompt generator 120 and sends prompt generator 120 to the AI engine 122. The AI engine 122 creates the video and transmits the video into the advertisement video 134 inside an advertisement module 136. The advertisement module 136 integrates the advertisement video with the AI teacher profile 106 and delivers it to the online learning platform 102.

In operation 210, profile 140 receives all the information provided by the AI engine 122. This includes the profile generated by the profile generation module 124, chat information created by the chat generation module 126, and videos from the video generation module 128. Profile 140 stores all the data from the AI engine 122. Profile 140 then gives the information to the online learning platform 102. For example, when creating an AI teacher for Isaac Newton, the AI engine 122 gives the basic information about Isaac Newton in text format to profile 140. The video generation module 128 produces different videos related to the content Isaac Newton is teaching, which the profile 140 stores and sends to the online learning platform 102. Similarly, when students learning through the online learning platform 102 have any doubts, the AI engine 122 generates answers and sends them to the online learning platform 102 through profile 140.

Profile 140 integrates the information into the online learning platform 102, allowing users to access the given data. The profile generation module 124 and chat generation module 126 in the AI engine 122 output data in JSON format. Profile 140 converts this JSON into natural language when integrating all the information into the online learning platform 102. In scenarios where the AI profile generation has been completed but needs more videos, the AI engine 122 generates only videos and integrates video into the online learning platform 102 through the AI teacher profile 106. Similarly, for the chat module 116, when a user has a particular question about the topic taught by the AI teacher, the content generation system 112 generates a prompt with the structure of the prompt created by a prompt engineer and supplies it to the AI engine 122. The AI engine 122 then outputs the response to profile 140, which integrates it into the user interaction 108 on the online learning platform 102.

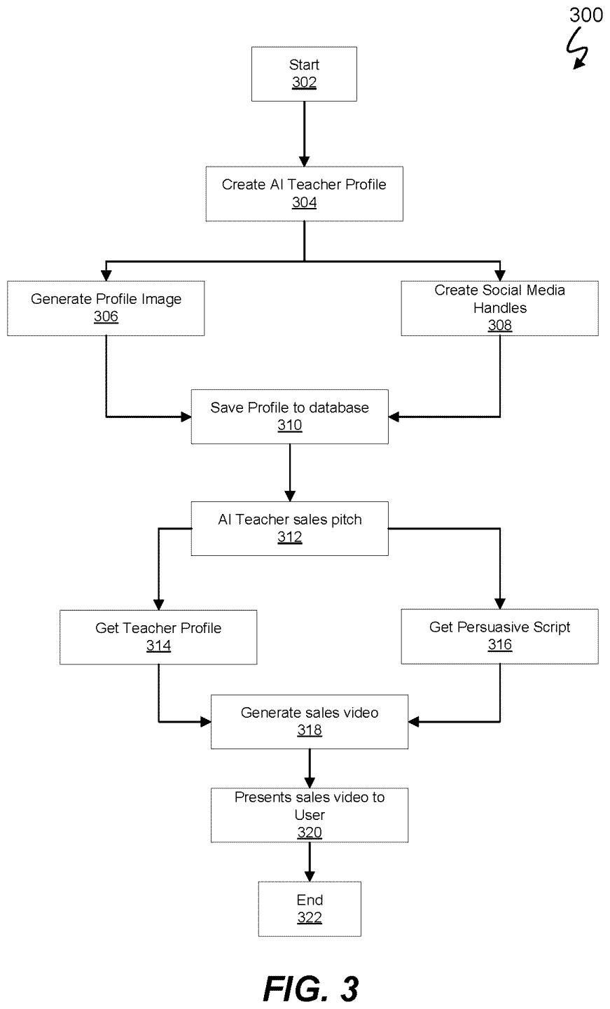

FIG. 3 depicts the flow 300 of the process for generating profiles for AI teachers, which is an embodiment of the profile generation process of FIG. 2. The process for generating profiles for AI teachers begins at the start 302 node, immediately branching into a create AI teacher profile 304 step. The creation of AI teacher profile 304 involves generating a detailed profile for an AI teacher, including the teacher's ID, name, subject, bio, and quotes. The created AI teacher profile 304 forms the foundation for all subsequent actions. Next, the process for generating profiles for AI teachers initiates two parallel processes at the same time: generate profile image 306 and create social media handles 308. These processes include GenAI tools like DALL-E and Midjourney. Concurrently, the create social media handles 308 tool creates social media handles, such as Twitter, LinkedIn, and Instagram, to give the AI teacher a more comprehensive online presence. Both the generated profile image and social media handles converge at the saved profile to the database, in step 310. This stage consolidates all the created information—the AI teacher's profile, image, and social media identities-into a database for easy retrieval and use.

The process for generating profiles for AI teachers then moves to the AI teacher sales pitch 312 phase. This step marks a transition from profile creation to the active use of the created profile for sales purposes. AI teacher sales pitch 312 serves as a central hub, coordinating the retrieval of necessary information for crafting a persuasive sales pitch. From the AI teacher sales pitch 312, two parallel processes are initiated: get teacher profile 314 and get persuasive script 316. The process for generating profiles for AI teachers retrieves the previously saved teacher profile from the database, ensuring all the created details are accurately represented. Simultaneously, at 316, a persuasive script 316 generates a persuasive script tailored to the specific characteristics of the AI teacher and the target audience. These two elements—the teacher profile and the persuasive script-feed into the generated sales video, at step 318. This stage represents a complex process where the system for AI-teacher profiles for sales uses advanced video generation technology such as D-ID and Heygen to create a realistic video featuring the AI teacher delivering the sales pitch.

The final step 320 in the process of generating profiles for AI teachers is to present a sales video to the user. The present sales video to user 320 delivers the generated video to the intended audience through a web interface such as social media or the online learning platform 102. The process for generating profiles for AI teachers concludes 322 at the end nodes, signifying the completion of the workflow.
a. Pseudo-code for AI Teacher Profiles

```
  # Function to create AI teacher profiles
  def create_ai_teacher_profile(teacher_id, teacher_data):
    “““
    Creates a profile for an AI teacher with relevant
educational content.
    Args:
    - teacher_id: A unique identifier for the AI teacher.
    - teacher_data: A dictionary containing the teacher's
details and content.
    Returns:
    - profile: A dictionary representing the AI teacher's
profile.
    ”””
    profile = {
      ‘id’: teacher_id,
      ‘name’: teacher_data[‘name’],
      ‘subjects': teacher_data[‘subjects'],
      ‘bio’: teacher_data[‘bio’],
      ‘quotes': teacher_data[‘quotes'],
      ‘image’:
generate_profile_image(teacher_data[‘image_path’]),
      ‘social_media’: create_social_media_handles(teacher_id)
    }
    # Save the profile to the database (reference to ContentGen
module for content creation)
    save_to_database(profile)
    return profile
  # Function to generate profile images for AI teachers
  def generate_profile_image(image_path):
    “““
    Generates a profile image for the AI teacher.
    Args:
    - image_path: The path to the image file.
    Returns:
    - image_url: The URL of the generated profile image.
    ”””
    # Image generation logic using GenAI technology (reference
to ContentGen module)
    image_url = genai_image_generator(image_path)
    return image_url
  # Function to create social media handles for AI teachers
  def create_social_media_handles(teacher_id):
    “““
    Creates social media accounts for the AI teacher.
    Args:
    - teacher_id: A unique identifier for the AI teacher.
    Returns:
    - social_handles: A dictionary of social media handles.
    ”””
    social_handles = {
      ‘tiktok’: f“@ai_teacher_{teacher_id}”,
      ‘instagram’: f“ai_teacher_{teacher_id}”,
      # Additional social media platforms can be added here
    }
    # Logic to register the AI teacher on social media platforms
    register_on_social_media(social_handles)
    return social_handles
  # Function to simulate AI teachers as salespeople
  def ai_teacher_sales_pitch(teacher_id, user_id,
product_details):
    “““
    Uses the AI teacher to upsell products to the user.
    Args:
    - teacher_id: A unique identifier for the AI teacher.
    - user_id: A unique identifier for the user.
    - product_details: Details of the product being sold.
    Returns:
    - success: Boolean indicating if the sales pitch was
successful.
    ”””
    # Retrieve the AI teacher's profile and persuasive script
    teacher_profile = get_teacher_profile(teacher_id)
    sales_script = get_persuasive_script(product_details)
    # Generate a sales video using GenAI technology (reference
to ContentGen module)
    sales_video_url =
genai_video_generator(teacher_profile[‘image’], sales_script)
    # Present the sales video to the user and track interaction
    success = present_sales_video(user_id, sales_video_url)
    return success
  # Helper function to save profiles to the database
  def save_to_database(profile):
    # Logic to save the AI teacher's profile to the database
    pass
  # Helper function to generate images using GenAI technology
  def genai_image_generator(image_path):
    # Logic to generate images using GenAI technology
    pass
  # Helper function to register AI teachers on social media
platforms
  def register_on_social_media(social_handles):
    # Logic to create social media accounts for AI teachers
    pass
  # Helper function to retrieve the AI teacher's profile
  def get_teacher_profile(teacher_id):
    # Logic to retrieve the AI teacher's profile from the
database
    pass
  # Helper function to get a persuasive script for the product
  def get_persuasive_script(product_details):
    # Logic to create a persuasive script for the product
    pass
  # Helper function to generate sales videos using GenAI
technology
  def genai_video_generator(image_url, script):
    # Logic to generate sales videos using GenAI technology
    pass
  # Helper function to present the sales video to the user
  def present_sales_video(user_id, video_url):
    # Logic to present the sales video to the user and track
interaction
    pass
```

The process for generating profiles for AI teachers, stores details about AI teachers in a historical figure database 140. Each entry in the historical figure database 140 includes the teacher's ID, name, subjects, biography, quotes, profile image, and social media handles. These details are stored as

teacher_id, teacher_data [‘name’], teacher_data [‘subjects’], teacher_data [′bio′], teacher_data [‘quotes’], generate_profile_image (teacher_data [‘image_path’]), and create_social_media_handles (teacher_id), respectively. Historical figure database 140 serves as a foundation for content generation system 112.

A function for profile picture generation is initiated and done through GenAI. The function generate_profile_image takes an image path (image_path) as an input, processes the image, and generates a profile image for the AI teacher, and the image is further processed by a function called genai_image_generator. This function takes the image_path as an input, processes it, and returns a URL to the generated image. This URL can then be used for displaying the profile image in a web application or for any other purpose requiring an online image link. Image_path denotes the path of the image file, while image_url denotes the URL of the generated image.

A function called ‘create social media handles’ sets up social media accounts for AI teachers. The function ‘create social media handles’ takes a unique ID for each AI teacher. The AI teacher uses this ID to create usernames for different social media platforms, like TikTok and Instagram. For example, if the AI teacher's ID is “123,” it might create a TikTok username like “@ai_teacher_123” and an Instagram username like “ai_teacher_123.” And the function ‘create social media handles’ puts all these usernames into a list called‘social_handles’. Additionally, the function create social media handles calls another helper function named ‘register_on_social_media’. This helper function, ‘register_on_social_media’, takes care of the actual process of setting up these accounts on each social media platform. Finally, the function ‘create_social_media_handles’ gives back the list of social media usernames it created. This way, other parts of the program can use these usernames to manage the AI teacher's social media presence.

A function called ‘ai_teacher_sales_pitch’, helps AI teachers sell products to users. The function takes three pieces of information: an ID for the AI teacher, an ID for the user, and details about the product being sold. The function ‘ai_teacher_sales_pitch’ uses these to create a personalized sales pitch. The function ‘ai_teacher_sales_pitch’ gets information about the AI teacher by calling another function called ‘get_teacher_profile’. ‘get_teacher_profile’ gives details about the teacher, like the AI teacher's name and teaching subjects. Additionally, the ‘ai_teacher_sales_pitch’ function creates a persuasive sales script for the product. The ‘ai_teacher_sales_pitch’ does this by calling a function called ‘get_persuasive_script’, which takes the product details and turns the product details into a convincing sales message. The function ‘ai_teacher_sales_pitch’ combines the teacher's profile and the sales script to create a tailored sales pitch. This pitch uses the AI teacher's personality to make the product more appealing to the user. Finally, the function ‘ai_teacher_sales_pitch’ tells whether the sales pitch worked or not. This helps track how successful the AI teachers are at selling products.

A function genai_video_generator makes a video using GenAI. It takes the AI teacher's picture and the sales script created and puts them together into a video. When it's done, it gives back a web address (URL) where the new video can be found. By calling another function called present_sales_video, shows this video to the user. This function, present_sales_video, not only plays the video for the user but also watches how the user reacts to the video. present_sales_video keeps track of things such as whether the user watches the whole video or clicks on any links in it. Moreover, the function present_sales_video finds out if the sales pitch worked. present_sales_video does this by looking at how the user responded to the video. If the user shows interest in or buys the product, the function considers the sales pitch successful. The function present_sales_video then reports back whether the sales pitch worked or not.

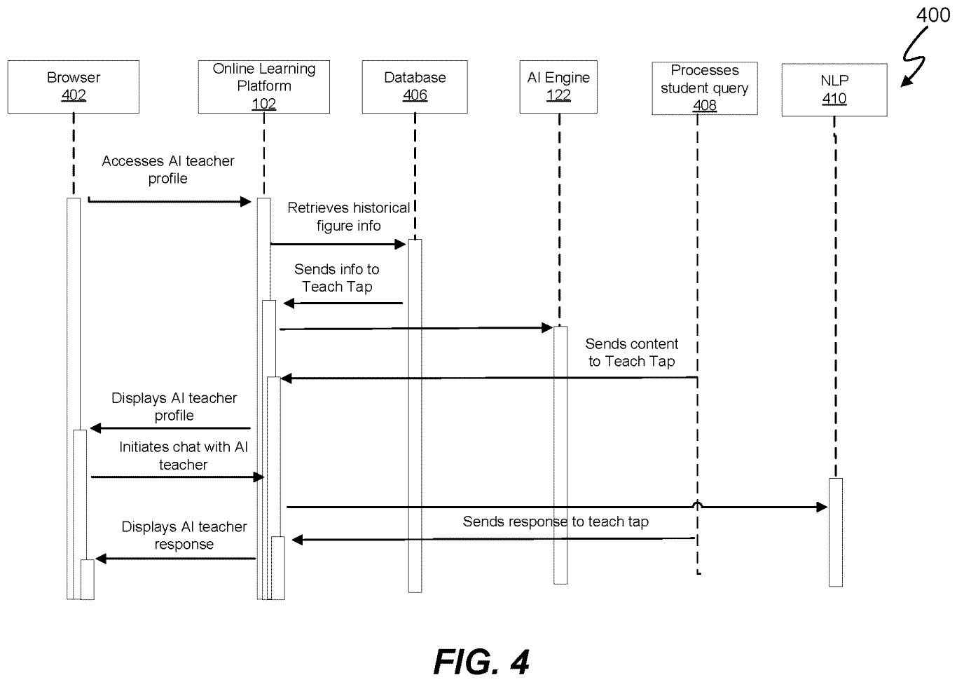

FIG. 4 depicts a user interaction process 400 where a user interacts with an AI teacher profile 106 on the online learning platform 102, which is an embodiment of the profile generation process of FIG. 2. The interaction process begins when the user clicks on an image or link of an AI teacher displayed on browser 402 that the user was accessing. The online learning platform 102 retrieves relevant information related to the AI teacher from its database 404. Additionally, the online learning platform 102 employs an AI engine 122 to generate personalized content for the user. Once the AI Engine 122 completes this task, the online learning platform 102 displays the customized AI teacher profile 106 in the user's browser.

Moreover, the interaction continues as the user initiates a chat with the AI teacher. The online learning platform 102 processes this input by sending it to a Natural Language Processing (NLP) 408 model. The NLP 408 analyzes the user's query and formulates an appropriate response. The online learning platform 102 receives this response from the NLP model and displays it in the user's browser 402, simulating a conversation with the AI teacher.

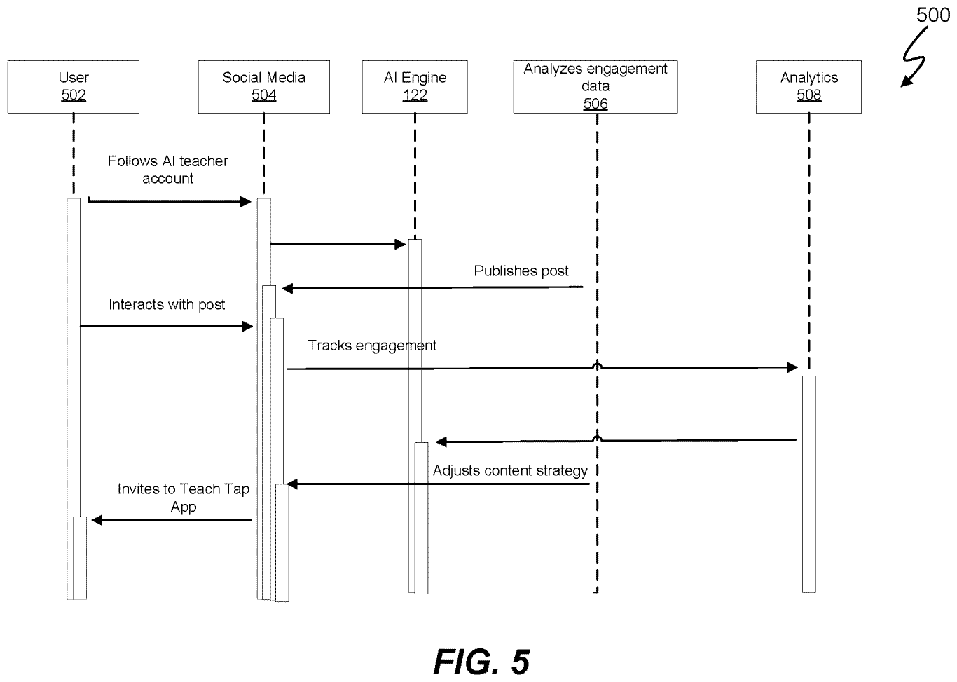

FIG. 5 depicts social media account management 500 for AI teachers, which is an embodiment of the profile generation process of FIG. 2. The social media account management for AI teachers begins when user 502 follows an AI teacher's account on a social media 504 platform. This triggers the social media 504 platform to request engaging content from the AI engine 122. The AI engine 122 generates posts, which the social media platform 504 then publishes. The user 502 interacts with this post, perhaps by liking, commenting, or sharing.

The social media 504 platform tracks these interactions and sends analyzed engagement data 506 to an analytics 508 system. The Analytics 508 system processes the data and provides insights to the AI engine 122. Based on analytics 508, the AI engine 122 adjusts its content strategy to better engage the user 502. Moreover, the social media 504 platform, likely based on the user's engagement level, sends an invitation to user 502 to use the online learning platform 102. This step aims to convert social media followers into active users of the online learning platform 102.

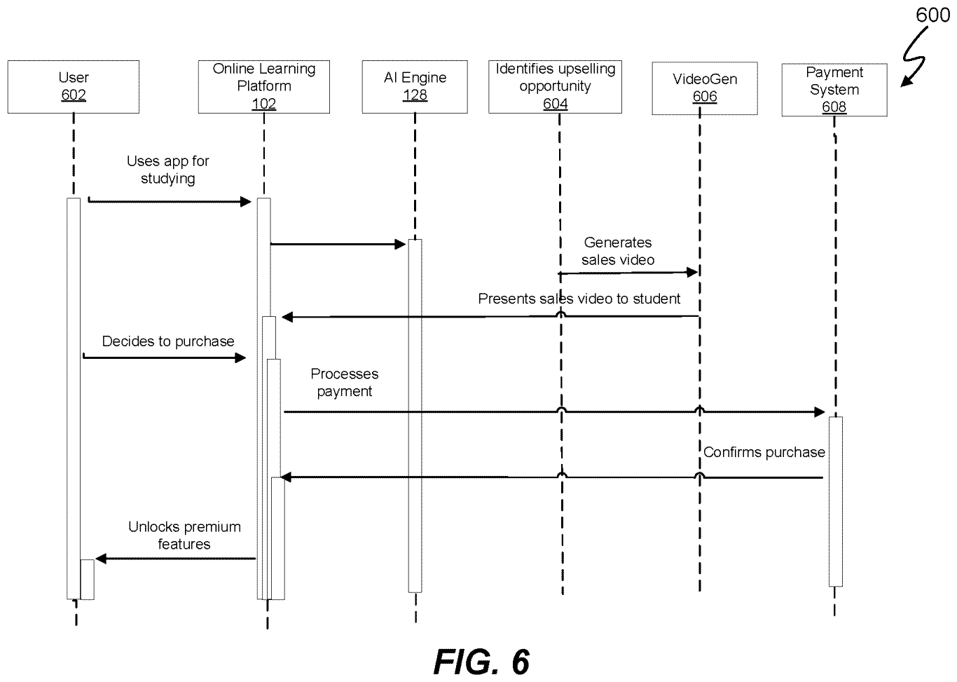

FIG. 6 depicts an AI teacher as a salesperson when a user uses the online learning platform 102 for studying, which is an embodiment of the profile generation process of FIG. 2. As user 602 interacts with the online learning platform 102, the online learning platform 102 communicates with an algorithm for advertising activation 150 to identify potential upselling opportunities based on the student's usage patterns and preferences. Once an identified upskilling opportunity 604, the algorithm for advertising activation 150 triggers a video generation system 606 to create a targeted sales video. This video is customized to highlight features or content that would be most appealing to a specific user based on the user's study habits and interests. Video generation system 606 (content generation system) then sends the completed sales video back to the online learning platform 102, which presents it to the user within the online learning platform 102. This presentation is designed to showcase the value of premium features or additional content.

If user 602 finds the offer appealing and decides to make a purchase, the algorithm for advertising activation 150 indicates this decision within the online learning platform 102. The online learning platform 102 then initiates a transaction with its Payment System 608 to process the user's 602 payment.

Once payment system 608 confirms that the transaction is successful, notify the online learning platform 102. In response, the online learning platform 102 unlocks the premium features or additional content for the user, granting the user 602 access to the newly purchased resources.

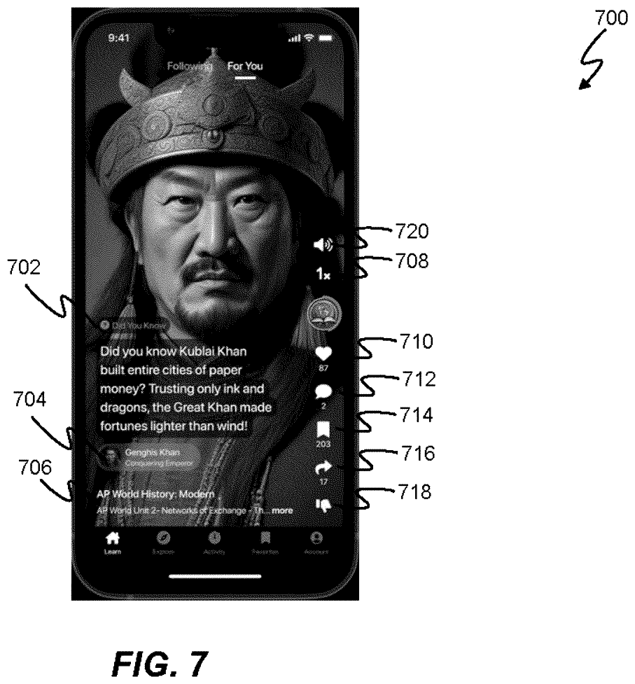

FIG. 7 depicts the user interface of the AI teacher profile on the online learning platform 102. The user interface features a personalized “Did You Know 702” text, which connects to the user's details and a subject an AI teacher covers. For instance, when a user explores Genghis Khan's profile, the “Did You Know” section relates to Genghis Khan's history and the subject Genghis Khan teaches on the online learning platform 102. A note below the profile picture describes the AI teacher's specialized subject 706, giving users a clear idea of what user can learn. For example, Genghis Khan mentions world history, while Isaac Newton's profile lists physics as his subject. Clicking the profile picture reveals a more detailed profile of the AI teacher, containing additional information about the AI teacher's biography, social media account, and available courses.

Moreover, for video content, the online learning platform 102 offers a playback speed control of 708. Users can increase or decrease video speed to match users learning pace, with multiple options available. A playback speed control feature allows students to customize users learning experience based on user's needs. Additionally, users can like 710, comment 712, save 714, share 716, or dislike posts 718. These interactions help the online learning platform 102 tailor future content to user preferences, creating a more personalized learning experience. The system for generating profiles for AI teachers analyzes comments to understand user interests and customize content accordingly. For example, users who like history-related profiles receive more suggestions in that area, while the system for generating profiles for AI teachers avoids suggesting similar profiles for disliked content. The user interface includes on-screen sound controls 720, enabling users to adjust volume without leaving the app or accessing device settings. This convenience enhances the user experience by keeping all necessary controls within easy reach.

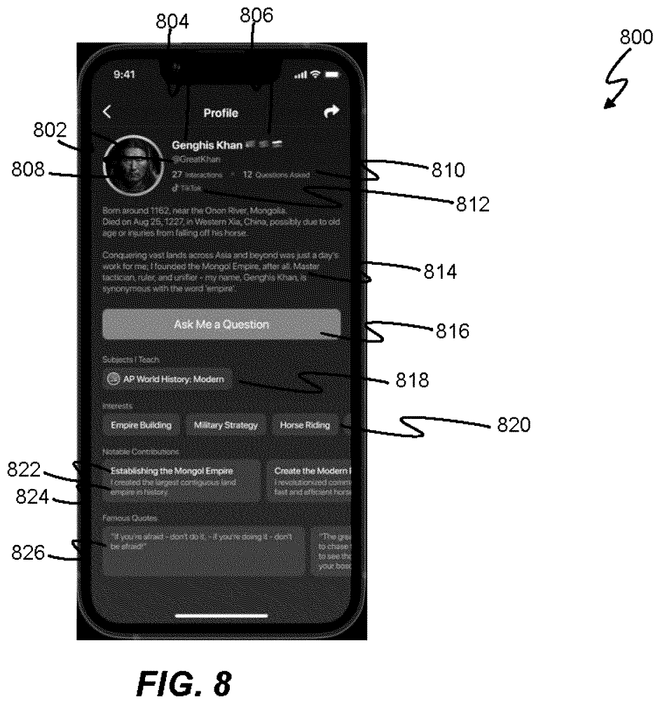

FIG. 8 depicts a detailed profile of the AI teacher who appears when tapping on the photo or the video content. In the detailed profile, there is informative content included, such as AI teacher introduction video 802, where the AI teacher will give an introduction along with achievements, which can be accessed when tapping on the profile picture of the AI teacher. Flag emojis 806 of the countries the figure is associated with; for example, if the AI teacher is from India, the India flag emoji will be displayed. AI teacher's social media handle 808. The number of “interactions” the user has had with the AI teacher and the number of questions the user asked the AI teacher are displayed as N Interactions. MQuestions Asked 810. Social media account 812 will link to the AI teacher's social media account; if it is not available, then nothing will be showing. If the AI teacher doesn't have a social media account, this clickable element will not exist.

Biography of an AI teacher 814 for which the first phrase for the first two lines is bold. “Born” and “died” start on new lines, and there is a space before the biography text. Ask me a question 816, which allows the user to communicate with the AI teacher. Subject AI teacher teaches 818. For example, if the AI teacher is Isaac Newton, then the subjects Isaac Newton handles will be physics and mathematics. Interest 820: In this section, the figure of interest will be mentioned in the space where if the AI teacher is Genghis Khan, then the interest shown will be empire building, military strategies, and course riding. Notable contribution 822: A contribution title is displayed in bold or emphasized font at the top. A contribution description is displayed in normal font under the title. And famous quotes: 826. The famous quotes said by the AI teacher will be mentioned, and if that AI teacher does not have any famous quotes, that section will not exist.

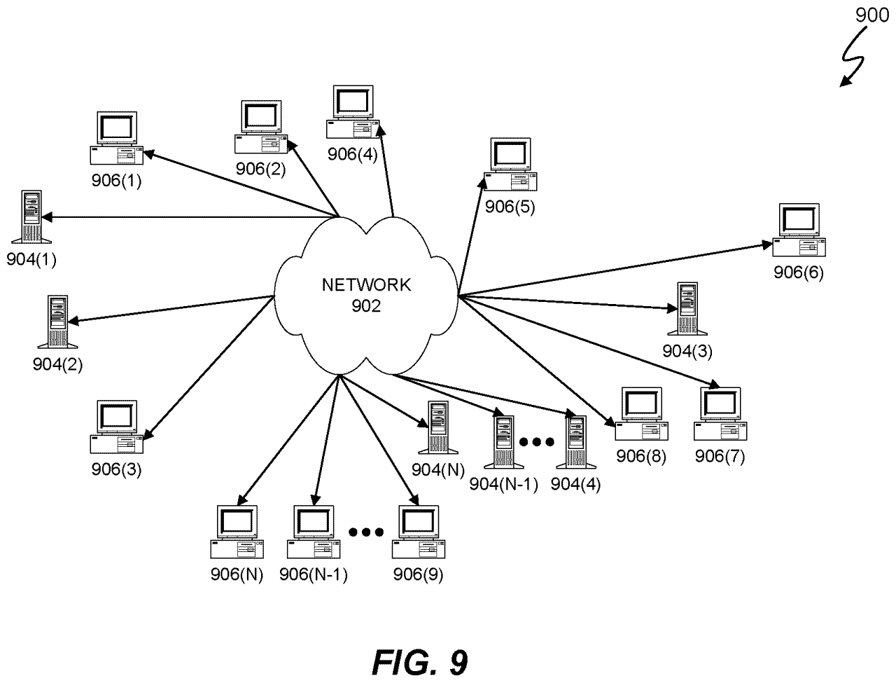

FIG. 9 is a block diagram illustrating a network environment in which a profile generation system 100 and a profile generation 200 be practiced. Network 902 (e.g. a private wide area network (WAN) or the Internet) includes several networked server computer systems 904(1)-(N) that are accessible by client computer systems 906(1)-(N), where N is the number of server computer systems connected to the network. Communication between client computer systems 906(1)-(N) and server computer systems 804(1)-(N) typically occurs over a network, such as a public switched telephone network over asynchronous digital subscriber line (ADSL) telephone lines or high-bandwidth trunks, for example, communications channels providing T1 or OC3 service. Client computer systems 906(1)-(N) typically access server computer systems 904(1)-(N) through a service provider, such as an internet service provider (“ISP”), by executing application-specific software, commonly referred to as a browser, on one of client computer systems 906(1)-(N).

Client computer systems 906(1)-(N) and server computer systems 904(1)-(N) are specialized computers programmed to improve conventional computer systems to implement and utilize the definition generation system 100 and a process 200 within the online learning platform 102. The type of computer system that can be specially programmed to implement and utilize the profile generation system 100 and profile generation process 200 includes a mainframe, a mini-computer, a personal computer system including notebook computers, a wireless, mobile computing device (including personal digital assistants, smartphones, and tablet computers). These computer systems are typically designed to provide computing power to one or more users locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the profile generation system 100 and profile generation process 200 can be implemented using code stored in a tangible, non-transient computer-readable medium and executed by one or more processors. In at least one embodiment, the profile generation system 100 and profile generation process 200 can be implemented completely in hardware using, for example, logic circuits and other circuits including field programmable gate arrays.

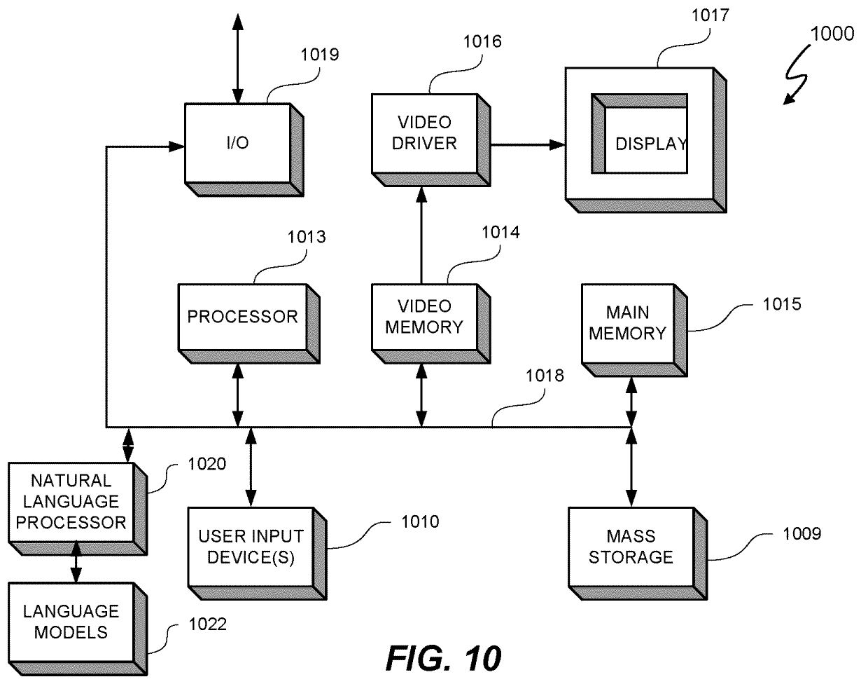

Embodiments of the profile generation system 100 and profile generation process 200 can be implemented on a computer system such as a special-purpose, special-programmed computer 1000 illustrated in FIG. 10. Input user device(s) 1010, such as a keyboard and/or mouse, are coupled to a bi-directional system bus 1018. The input user device(s) 1010 are for introducing user input to the computer system and communicating that user input to processor 1013. The computer system of FIG. 10 generally also includes a non-transitory video memory 1014, non-transitory main memory 1015, and non-transitory mass storage 1009, all coupled to bi-directional system bus 1018 along with input user device(s) 1010 and processor 1013. The mass storage 1009 may include fixed and removable media, such as a hard drive, one or more CDs or DVDs, solid state memory including flash memory, and other available mass storage technology. Bus 1018 may contain, for example, 32 of 64 address lines for addressing video memory 1014 or main memory 1015. The system bus 1018 also includes, for example, an n-bit data bus for transferring DATA between and among the components, such as CPU 2609, main memory 1015, video memory 1014, and mass storage 1009, where “n” is, for example, 32 or 64. Alternatively, multiplex data/address lines may be used instead of separate data and address lines.

I/O device(s) 1019 may provide connections to peripheral devices, such as a printer, and may also provide a direct connection to a remote server computer system via a telephone link or to the Internet via an ISP. I/O device(s) 1019 may also include a network interface device to provide a direct connection to a remote server computer system via a direct network link to the Internet via a POP (point of presence). Such connection may be made using, for example, wireless techniques, including digital cellular telephone connection, Cellular Digital Packet Data (CDPD) connection, digital satellite data connection, or the like. Examples of I/O devices include modems, sound and video devices, and specialized communication devices such as the aforementioned network interface.

Computer programs and data are generally stored as code in a non-transient computer-readable medium such as flash memory, optical memory, magnetic memory, compact disks, digital versatile disks, and any other type of memory. The computer program is loaded from a memory, such as mass storage 1009, into main memory 1015 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 1013, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 1015 consists of dynamic random access memory (DRAM). Video memory 1014 is a dual-ported video random access memory. One port of the video memory 91014 is coupled to the video amplifier 1016. The video amplifier 1016 is used to drive the display 1017. Video amplifier 1016 is well-known in the art and may be implemented by any suitable means. This circuitry converts pixel DATA stored in video memory 1014 to a raster signal suitable for use by display 1017. Display 1017 is a type of monitor suitable for displaying graphic images.

The computer system described above is for purposes of example only. The profile generation system 100 and profile generation process 200 may be implemented in any type of computer system programming or processing environment. It is contemplated that the profile generation system 100 and profile generation process 200 might be run on a stand-alone computer system, such as the one described above. The profile generation system 100 and profile generation process 200 might also be run from a server computer systems system that can be accessed by a plurality of client computer systems interconnected over an intranet network. Finally, the profile generation system 100 and profile generation process 200 may be run from a server computer system that is accessible to clients over the Internet.

Although embodiments have been described in detail, it should be understood that various changes, substitutions, and alterations can be made herein without departing from the spirit and scope of the invention as defined by the appended claims.

What is claimed is:

1. A method for guiding and constraining an Artificial Intelligence (AI) engine for generating profiles for AI teachers within an online learning platform, the method comprising:
executing code using one or more processors of a computer system to cause the computer system to perform operations comprising:
retrieving information associated with historical figures from a database;
parsing user interaction data on the online learning platform to identify the engagement of each user with each historical figure;
utilizing a content generation module for preparing content for the AI teachers, wherein the content generation module is configured to identify the relevant information associated with the historical figures;
generating a prompt to guide and constrain the AI engine to generate AI teacher profiles corresponding to the historical figures to utilize within the online learning platform by using the generated content and user interaction data;
transferring the prompt to the AI engine to generate the AI teacher profiles and integrate the generated AI teacher profiles within the online learning platform; and
utilizing the AI teacher profiles to create social media accounts for the AI teachers to allow the user to interact with the AI teacher profiles on social media platforms.

2. The method of claim 1 wherein utilizing
engagement analysis algorithm to analyze the user interaction data to determine the frequency of the user engagement with the AI teacher profiles; and
content personalization algorithm to tailors the AI teacher profiles based on the user preferences and performance data.

3. The method of claim 1 wherein integrating social media management tools for AI teachers profile comprising:
implementing a scheduling module within the online learning platform to allow to schedule posts of the for AI teachers on the social media at predetermined times; and
integrating an engagement tracking system within the online learning platform configured to monitor and analyze interactions on the social media accounts of the AI teacher.

4. The method of claim 1 further comprising:
implementing a content optimization algorithm within the online learning platform, wherein the content optimization algorithm:
analyzes engagement data collected from social media interactions, including metrics such as likes, comments, shares, and follower growth;
determines the most effective content types that resonate with the user, based on the engagement data;
identifies the optimal posting times to maximize user engagement, considering factors such as time zones, user activity patterns, and past interaction times; and
provides recommendations for future content creation and posting schedules to enhance engagement and educational outcomes.

5. The method of claim 4 further comprising:
implementing an engagement tracking algorithm within the within the online learning platform, wherein the engagement tracking algorithm:
monitors and collects engagement metrics from the AI teachers' social media accounts, including likes, comments, and shares; and
measures the success of social media strategies by analyzing the collected engagement metrics.

6. The method of claim 1 wherein implementing a chat interface to allow text-based interactions between the user and AI teachers.

7. The method of claim 6 further comprising:
utilizing natural language processing (NLP) algorithms to interpret and understand user interaction with the AI teachers in real time to generate coherent and contextually appropriate responses from AI teachers.

8. The method of claim 1 wherein utilizing content templates to generate posts for the social media accounts for the AI teacher profiles.

9. A system for guiding an Artificial Intelligence (AI) engine for generating profiles for AI teachers within an online learning platform, the system comprising:
one or more processors;
a memory, coupled to the one or more processors, storing code that when executed causes the one or more processors to perform operations comprising:
executing code using one or more processors of a computer system to cause the computer system to perform operations comprising:
retrieving information associated with historical figures from a database;
parsing user interaction data on the online learning platform to identify the engagement of each user with each historical figure;
utilizing a content generation module for preparing content for the AI teachers, wherein the content generation module is configured to identify the relevant information associated with the historical figures;
generating a prompt to guide the AI engine to generate AI teacher profiles corresponding to the historical figures to utilize within the online learning platform by using the generated content and user interaction data;
transferring the prompt to the AI engine to generate the AI teacher profiles and integrate the generated AI teacher profiles within the online learning platform; and
utilizing the AI teacher profiles to create social media accounts for the AI teachers to allow the user to interact with the AI teacher profiles on social media platforms.

10. The system of claim 9 wherein utilizing comprises a engagement analysis algorithm to analyze the user interaction data to determine the frequency of the user engagement with the AI teacher profiles; and
content personalization algorithm to tailors the AI teacher profiles based on the user preferences and performance data.

11. The system of claim 9 wherein integrating a social media management tool for AI teachers profile comprising:
implementing a scheduling module within the online learning platform to allow to schedule posts of the for AI teachers on the social media at predetermined times; and
integrating an engagement tracking system within the online learning platform configured to monitor and analyze interactions on the social media accounts of the AI teacher.

12. The system of claim 9 further comprising:
implementing a content optimization algorithm within the online learning platform, wherein the content optimization algorithm:
analyzes engagement data collected from social media interactions, including metrics such as likes, comments, shares, and follower growth; and
determines the most effective content types that resonate with the user, based on the engagement data.
identifies the optimal posting times to maximize user engagement, considering factors such as time zones, user activity patterns, and past interaction times; and
provides recommendations for future content creation and posting schedules to enhance engagement and educational outcomes.

13. The system of claim 12 further comprising:
implementing an engagement tracking algorithm within the within the online learning platform, wherein the engagement tracking algorithm:
monitors and collects engagement metrics from the AI teachers' social media accounts, including likes, comments, and shares; and
measures the success of social media strategies by analyzing the collected engagement metrics.

14. The system of claim 9 wherein implementing a chat interface to allow text-based interactions between the user and AI teachers.

15. The system of claim 14 further comprising:
utilizing natural language processing (NLP) algorithms to interpret and understand user interaction with the AI teachers in real time to generate coherent and contextually appropriate responses from AI teacher profiles.

16. The system of claim 9 wherein utilizing content templates to generate posts for the social media accounts for the AI teacher profiles.
